(19) United States
(12) Patent Application Publication
(10) Pub. No.: US 2020/0175397 A1
(43) Pub. Date: Jun. 4, 2020

(54) METHOD AND DEVICE FOR TRAINING A TOPIC CLASSIFIER, AND COMPUTER-READABLE STORAGE MEDIUM

(71) Applicant: Ping An Technology (Shenzhen) Co., Ltd., Shenzhen, Guangdong (CN)

(72) Inventors: Jianzong Wang, Shenzhen, Guangdong (CN); Zhangcheng Huang, Shenzhen, Guangdong (CN); Tianbo Wu, Shenzhen, Guangdong (CN); Jing Xiao, Shenzhen, Guangdong (CN)

(21) Appl. No.: 16/314,398

(22) PCT Filed: Sep. 28, 2017
(86) PCT No.: PCT/CN2017/104106

§ 371 Date: Dec. 29, 2018

(30) Foreign Application Priority Data
Aug. 25, 2017 (CN) 201710741128.7

(51) Int. Cl. G06N 5/04; G06N 20/00; G06F 16/22; G06F 16/28; G06F 40/30; G06F 40/279

(52) U.S. Cl. CPC G06N 5/04; G06N 20/00; G06F 40/279; G06F 16/285; G06F 40/30; G06F 16/2255

(57) ABSTRACT

Provided is a method for training a topic classifier: obtaining a training sample and a test sample, wherein the training sample is obtained by manually labeling after a corresponding topic model having been trained based on text data; extracting features of the training sample and of the test sample respectively using a preset algorithm, computing optimal model parameters of a logistic regression model by an iterative algorithm based on the features of the training sample, to train and get a logistic regression model containing the optimal model parameters; and drawing a ROC curve based on the features of the test sample and the logistic regression model containing the optimal model parameters, evaluating the logistic regression model containing the optimal model parameters based on the area AUC under the ROC curve, to train and get a first topic classifier. It further discloses a device and computer-readable storage medium thereof.

### FIELD

The present disclosure relates to the field of information processing, and more particularly to a method and device for training a topic classifier, and computer-readable storage medium.

### BACKGROUND

In recent years, with the rapid development of the Internet, information resources are growing exponentially. Abundant Internet information resources have brought great convenience to people's lives. People can obtain various types of information resources such as audio and video media, news reports, and technical literatures only by connecting a computer to the Internet.

However, in the era of big data, the classification efficiency and accuracy of existing classification techniques are relatively low, as a result, it difficult for users to obtain relevant topic information accurately and quickly in front of massive information resources. Therefore, how to improve the efficiency and accuracy of topic classification is a technical problem to be solved by those skilled in the art.

### SUMMARY

The present disclosure is to provide a method and device for training a topic classifier, and computer-readable storage medium, which aims to improve the efficiency and accuracy of topic classification, so that users can effectively obtain relevant topic information from massive information.

In order to achieve the above aim, the present disclosure provides a method for training a topic classifier which includes:

obtaining a training sample and a test sample, wherein the training sample is obtained by manually labeling after a corresponding topic model having been trained based on text data;

extracting features of the training sample and of the test sample respectively using a preset algorithm, computing optimal model parameters of a logistic regression model by an iterative algorithm based on the features of the training sample, to train and get a logistic regression model containing the optimal model parameters; and

drawing a ROC curve of receiver operating characteristic based on the features of the test sample and the logistic regression model containing the optimal model parameters, and evaluating the logistic regression model containing the optimal model parameters based on the area AUC under the ROC curve, to train and get a first topic classifier.

Furthermore, in order to achieve the above aim, the present disclosure provides a device for training a topic classifier which includes: a memory, a processor, and a topic classifier training program stored in the memory and executable on the processor, the topic classifier training program when executed by the processor performing the above operations of the method for training the topic classifier.

Furthermore, in order to achieve the above aim, the present disclosure provides a computer-readable storage medium, wherein a topic classifier training program is stored in the computer-readable storage medium, the topic classifier training program when executed by the processor performing the above operations of the method for training the topic classifier.

Furthermore, in order to achieve the above aim, the present disclosure provides a device for training a topic classifier which includes:

a first obtaining module, configured for obtaining a training sample and a test sample, wherein the training sample is obtained by manually labeling after a corresponding topic model having been trained based on text data;

a first training module, configured for extracting features of the training sample and of the test sample respectively using a preset algorithm, computing optimal model parameters of a logistic regression model by an iterative algorithm based on the features of the training sample, to train and get a logistic regression model containing the optimal model parameters; and

a second training module, configured for drawing a ROC curve of receiver operating characteristic based on the features of the test sample and the logistic regression model containing the optimal model parameters, and evaluating the logistic regression model containing the optimal model parameters based on the area AUC under the ROC curve, to train and get a first topic classifier.

In the present disclosure, the training sample and the test sample are obtained, wherein the training sample is obtained by manually labeling after the corresponding topic model having been trained based on text data; features of the training sample and the test sample are extracted respectively using the preset algorithm, and optimal model parameters of the logistic regression model are computed by the iterative algorithm based on the features of the training sample, the logistic regression model containing the optimal model parameters is trained and got; the ROC curve of receiver operating characteristic is drawn based on the features of the test sample and the logistic regression model containing the optimal model parameters, and the logistic regression model containing the optimal model parameters is evaluated based on the area AUC under the ROC curve, the first topic classifier is trained and got. Through the above method, the present disclosure performs feature extracting to the training sample and the test sample using the preset algorithm which shortens the time of feature extracting and model training and improves the classification efficiency. The present disclosure selects the training sample by manually labeling which could improve the accuracy of the training sample, so as to improve the classification accuracy of the topic classifier, meanwhile, performing evaluating the logistic regression model containing the optimal model parameters through the area AUC under the ROC curve to train the topic classifier, so as to perform classification to the text data, which could further improve the accuracy of topic classification.

### BRIEF DESCRIPTION OF THE DRAWINGS

FIG. 1 is a structural diagram illustrating a topic classifier device of an embodiment according to the present disclosure.

FIG. 2 is a flowchart illustrating a first embodiment of the method for training a topic classifier according to the present disclosure.

FIG. 3 is a detailed flowchart illustrating obtaining a training sample and a test sample, wherein the training sample is obtained by manually labeling after a corresponding topic model having been trained based on text data of an embodiment according to the present disclosure.

FIG. 4 is a detailed flowchart illustrating drawing a ROC curve of receiver operating characteristic based on the features of the test sample and the logistic regression model containing the optimal model parameters, and evaluating the logistic regression model containing the optimal model parameters based on the area AUC under the ROC curve, to train and get a first topic classifier of an embodiment according to the present disclosure.

FIG. 5 is a flowchart illustrating a second embodiment of the method for training a topic classifier according to the present disclosure.

FIG. 6 is a detailed flowchart illustrating collecting the text data, and preprocessing the text data to obtain a corresponding first keyword set of an embodiment according to the present disclosure.

Various implementations, functional features, and advantages of the present disclosure will now be described in further detail with reference to the accompanying drawings and some illustrative embodiments.

### DETAILED DESCRIPTION OF THE EMBODIMENTS

It is to be understood that, the specific embodiments described herein portrays merely some illustrative embodiments of the present disclosure, and are not intended to limit the patentable scope of the present disclosure.

Due to the low classification efficiency and accuracy of the existing classification technology, it is difficult for a user to obtain the relevant topic information required by the user accurately and quickly in front of massive information resources.

In order to achieve the above aim, the present disclosure provides a method for training a topic classifier: obtaining a training sample and a test sample, wherein the training sample is obtained by manually labeling after a corresponding topic model having been trained based on text data; extracting features of the training sample and of the test sample respectively using a preset algorithm, computing optimal model parameters of a logistic regression model by an iterative algorithm based on the features of the training sample, to train and get a logistic regression model containing the optimal model parameters; and drawing a ROC curve of receiver operating characteristic based on the features of the test sample and the logistic regression model containing the optimal model parameters, and evaluating the logistic regression model containing the optimal model parameters based on the area AUC under the ROC curve, to train and get a first topic classifier. Through the above method, the present disclosure performs feature extracting to the training sample and the test sample using the preset algorithm which shortens the time of feature extracting and model training and improves the classification efficiency. The present disclosure selects the training sample by manually labeling which could improve the accuracy of the training sample, so as to improve the classification accuracy of the topic classifier, meanwhile, performing evaluating the logistic regression model containing the optimal model parameters through the area AUC under the ROC curve to train the topic classifier, so as to perform classification to the text data, which could further improve the accuracy of topic classification.

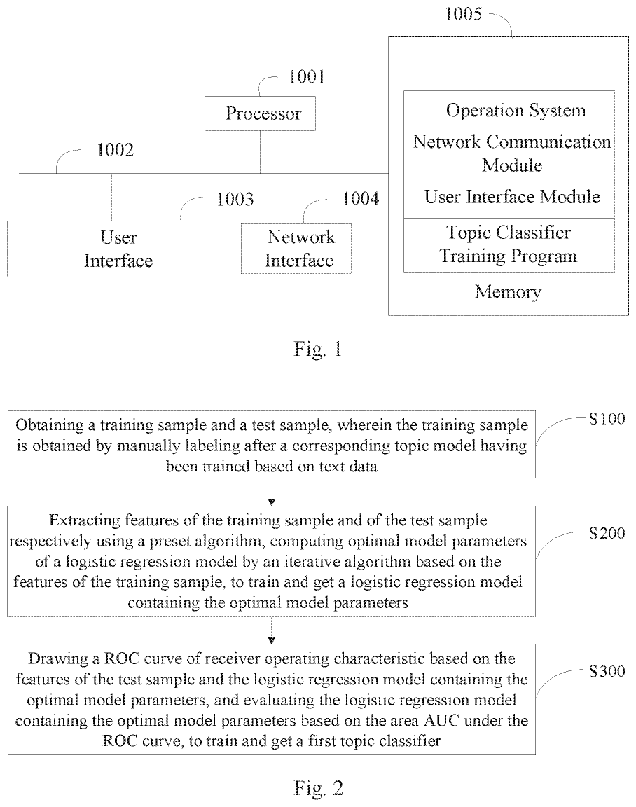

Referring to FIG. 1, FIG. 1 is a structural diagram illustrating a topic classifier device of an embodiment according to the present disclosure.

The device in the embodiment of the present invention may be a PC, or may be a terminal device with a display function, such as a smart phone, a tablet computer, or a portable computer.

As shown in FIG. 1, the device may include a processor 1001, such as a CPU, a network interface 1004, a user interface 1003, a memory 1005, and a communication bus 1002. Among them, the communication bus 1002 is configured to facilitate the connection communication between these components. The user interface 1003 may include a display, an input unit such as a keyboard, and the user interface 1003 may optionally also include a standard wired interface, a wireless interface. The network interface 1004 may optionally include a standard wired interface, a wireless interface (such as a WI-FI interface). The memory 1005 may be a high speed RAM memory or a non-volatile memory such as a magnetic disk memory. The memory 1005 may optionally be a storage device that is separate from the aforementioned processor 1001.

Optionally, the device may further include a camera, an RF (Radio Frequency) circuit, a sensor, an audio circuit, a WiFi module, and the like. Among them, the sensor such as a light sensor, a motion sensor, and other sensors. Specifically, the light sensor may include an ambient light sensor and a proximity sensor, wherein the ambient light sensor may adjust the brightness of the display based on the brightness of the ambient light, and the proximity sensor may turn off the display and/or the backlight when the device moves near the ear. As a kind of the motion sensor, a gravity acceleration sensor can detect the magnitude of acceleration in each direction (usually three axes). When at rest it can detect the magnitude and direction of the gravity, and it can be used in applications for identifying the attitude of a mobile terminal (e.g., switching between landscape and portrait screen modes, related games, magnetometer attitude calibration), vibration identification related functions (e.g., pedometer, tapping), and so on. The mobile terminal can of course also be equipped with other sensors such as a gyroscope, a barometer, a hygrometer, a thermometer, an infrared sensor, etc.; however it will not be detailed herein.

Persons skilled in the art can understand that the device structure illustrated in FIG. 1 is not meant to limit the device, the device may include more or fewer components than illustrated, or some components may be combined, or different component arrangements may be implemented.

As illustrated in FIG. 1, the memory 1005 as a computer storage medium may include an operating system, a network communication module, a user interface module, and a topic classifier training program.

In the device illustrated in FIG. 1, the network interface 1004 is mainly used to connect to a backend server and perform data communication with the backend server. The user interface 1003 is mainly used to connect to a client and perform data communication with the client. The processor 1001 can be used to invoke the topic classifier training program stored in the memory 1005 and perform the following operations:

obtaining a training sample and a test sample, wherein the training sample is obtained by manually labeling after a corresponding topic model is trained based on text data;

extracting features of the training sample and of the test sample respectively using a preset algorithm, computing optimal model parameters of a logistic regression model by an iterative algorithm based on the features of the training sample, to train and get a logistic regression model containing the optimal model parameters; and

drawing a ROC curve of receiver operating characteristic based on the features of the test sample and the logistic regression model containing the optimal model parameters, and evaluating the logistic regression model containing the optimal model parameters based on the area AUC under the ROC curve, to train and get a first topic classifier.

Further, the processor 1001 can invoke the topic classifier training program stored in the memory 1005 and perform the following operations:

collecting the text data, and preprocessing the text data to obtain a corresponding first keyword set;

computing a distribution of the text data on a preset number of topics using a preset topic model based on the first keyword set and the preset number of topics, and clustering the text data based on the distribution of the text data on the topics, to train and get the corresponding topic models of the text data; and

selecting from among the text data the training samples that correspond to a target topic classifier based on the manual labeling results on the text data based on the topic models, and using the text data other than the training samples as the test sample.

Further, the processor 1001 can invoke the topic classifier training program stored in the memory 1005 and perform the following operations:

extracting the features of the training sample and of the test sample respectively using a preset algorithm, and correspondingly establishing a first hash table and a second hash table;

substituting the first hash table into the logistic regression model, and calculating the optimal model parameters of the logistic regression model using the iterative algorithm, to train and get the logistic regression model containing the optimal model parameters.

Further, the processor 1001 can invoke the topic classifier training program stored in the memory 1005 and perform the following operations:

substituting the second hash table into the logistic regression model containing the optimal model parameters to obtain true positive TP, true negative TN, false negative FN, and false positive FP;

drawing the ROC curve based on TP, TN, FN and FP:

calculating the area AUC under the ROC curve, and evaluating the logistic regression model containing the optimal model parameters based on the AUC value;

when the AUC value is less than or equal to a preset AUC threshold, determining that the logistic regression model containing the optimal model parameters does not meet the requirement, and returning to the following operation: computing optimal model parameters of the logistic regression model using the iterative algorithm so as to train and get the logistic regression model containing the optimal model parameters;

otherwise when the AUC value is greater than the preset AUC threshold, determining that the logistic regression model containing the optimal model parameters meets the requirement, and trains to get the first topic classifier.

Further, the processor 1001 can invoke the topic classifier training program stored in the memory 1005 and perform the following operations:

calculating a false positive rate FPR and a true positive rate TPR based on TP, TN, FN, and FP, wherein their respective calculation formulas are FPR=FP/(FP+TN), TPR=TP/(TP+FN); and

drawing the ROC curve taking the FPR as the abscissa and the TPR as the ordinate.

Further, the processor 1001 can invoke the topic classifier training program stored in the memory 1005 and perform the following operations:

substituting the second hash table into the first topic classifier to obtain a probability that the test sample belongs to a corresponding topic;

adjusting the preset AUC threshold, and calculating a precision rate p and a recall rate r based on TP, FP, and FN;

when the p is less than or equal to a preset p threshold, or the r is less than or equal to a preset r threshold, returning to the following operation: adjusting the preset AUC threshold until the p is greater than the preset p threshold, and the r is greater than the preset r threshold, and training to get the second topic classifier.

Further, the processor 1001 can invoke the topic classifier training program stored in the memory 1005 and perform the following operations:

classifying the text data using the second topic classifier.

Further, the processor 1001 can invoke the topic classifier training program stored in the memory 1005 and perform the following operations:

collecting the text data, and segmenting the text data;

removing stop words in the text data after the segmentation based on a preset stop word list, to obtain a second keyword set;

calculating a term frequency-inverse document frequency TF-IDF value of each keyword in the second keyword set, and removing the keyword whose TF-IDF value is lower than a preset threshold of TF-IDF, to obtain the corresponding first keyword set.

Further, the processor 1001 can invoke the topic classifier training program stored in the memory 1005 and perform the following operations:

calculating the term frequency TF and the inverse document frequency IDF of each keyword in the second keyword set;

calculating the term frequency-inverse document frequency TF-IDF value of each keyword in the second keyword set, and removing the keyword whose TF-IDF value is lower than the preset threshold of TF-IDF, to obtain the corresponding first keyword set.

Referring to FIG. 2, FIG. 2 is a flowchart illustrating a first embodiment of the method for training a topic classifier according to the present disclosure.

In the present disclosure, the method for training the topic classifier includes:

S100, obtaining a training sample and a test sample, wherein the training sample is obtained by manually labeling after a corresponding topic model having been trained based on text data;

S200, extracting features of the training sample and of the test sample respectively using a preset algorithm, computing optimal model parameters of a logistic regression model by an iterative algorithm based on the features of the training sample, to train and get a logistic regression model containing the optimal model parameters;

In this embodiment, the training sample and the test sample required by training topic classifier are obtained, the training sample is obtained by manually labeling after the corresponding topic model is trained based on the text data, configured for optimizing the parameters of the model, while the test sample is the text data other than the training sample, configured for evaluating the performance of the established model. In a specific embodiment, the acquisition of the training sample and the test sample can also be sampled directly from the microblogs found in the Internet by a program, such as the Svmtrain function in the mathematical software Matlab.

Further, the features of the training sample and the test sample are respectively extracted using the preset algorithm. In this embodiment, the features of the training sample and the test sample are respectively extracted by using a Byte 4-gram algorithm of a binary hash table. Each training sample or test sample is correspondingly represented as a feature vector consisting of a set of features. The method extracts all consecutive 4 bytes in each training sample or test sample data as a key, converts the string into a byte array corresponding to UTF-8 encoding of the string, whose value is 32 bit integer. Further, a hash function is established through the remainder method, and a first hash table and a second hash table are respectively correspondingly established. Among them, it should be noted that the hash function formula for the hash table with a length m is: f(key)=key mod p, (p≤m). Wherein the mod represents the remainder. In a specific implementation method, in order to reduce the occurrence of conflicts, and to avoid the hash table distribution to be too sparse, usually p is the largest prime number smaller than the hash table length.

Further, substitute the first hash table into the logistic regression model, and iteratively compute the optimal model parameters by an optimization method, and the logistic regression model is trained, wherein the logistic regression model is configured to estimate the possibility of a certain thing, or to determine the probability that a sample belongs to a certain category. The logistic regression model is:

Wherein, xⱼ represents the eigenvector of the j^{th} training sample, x⁽ⁱ⁾ represents the i^{th} sampling, and θ represents the model parameters.

In addition, it should be noted that the iterative algorithm includes gradient descent, conjugate gradient method and quasi-Newton method. In a specific embodiment, the optimal model parameters of the logistic regression model can be computed by any of the above iterative algorithms, and the logistic regression model containing optimal model parameters is trained. Certainly, in a specific embodiment, other methods may be used to respectively extract features of the training sample and of the test sample, such as a vector space model VSM, an information gain method, and an expected cross entropy.

S300, drawing a ROC curve of receiver operating characteristic based on the features of the test sample and the logistic regression model containing the optimal model parameters, and evaluating the logistic regression model containing the optimal model parameters based on the area AUC under the ROC curve, to train and get a first topic classifier.

In this embodiment, the second hash table established based on the test sample is substituted into the logistic regression model containing the optimal model parameters, thereby obtaining true positive TP, true negative TN, false negative FN and false positive FP, wherein TP is the number of positive class after using the logistic regression model to judge the positive class in the training sample, TN is the number of negative class after using the logistic regression model to judge the negative classes in the training sample, FN is the number of positive class after using the logistic regression model to judge the negative classes in the training sample, FP is the number of negative class after using the logistic regression model to judge the positive classes in the training sample. The positive class and the negative class refer to two categories labeled manually to the training sample. That is, if a sample is manually labeled as belonging to a specific class, the sample belongs to the positive class, and the sample that does not belong to that particular class belongs to the negative class. Based on TP, TN, FN and FP, a false positive rate FPR and a true positive rate TPR are calculated. The ROC curve is drawn with FPR as the abscissa and TPR as the ordinate. The ROC curve is a characteristic curve of each indicator obtained, configured to demonstrate a relationship between the indicators. Further, the area AUC under the ROC curve is calculated, AUC is the area under the ROC curve, the greater the AUC, the better it is, meaning that the diagnostic value of the test is higher. Perform evaluating to the logistic regression model containing the optimal model parameters, when the AUC value is less than or equal to a preset AUC threshold, it is determined that the logistic regression model containing the optimal model parameters does not meet the requirement, and returning to the following operation: computing optimal model parameters of the logistic regression model using the iterative algorithm so as to train and get the logistic regression model containing the optimal model parameters, until the AUC value is greater than the preset AUC threshold, it is determined that the logistic regression model containing the optimal model parameters meets the requirement, and the first subject classifier has been trained.

In the present disclosure, the training sample and the test sample are obtained, wherein the training sample is obtained by manually labeling after the corresponding topic model having been trained based on text data; features of the training sample and the test sample are extracted respectively using the preset algorithm, and optimal model parameters of the logistic regression model are computed by the iterative algorithm based on the features of the training sample, the logistic regression model containing the optimal model parameters is trained and got; the ROC curve of receiver operating characteristic is drawn based on the features of the test sample and the logistic regression model containing the optimal model parameters, and the logistic regression model containing the optimal model parameters is evaluated based on the area AUC under the ROC curve, the first topic classifier is trained and got. Through the above method, the present disclosure performs feature extracting to the training sample and the test sample using the preset algorithm which shortens the time of feature extracting and model training and improves the classification efficiency. The present disclosure selects the training sample by manually labeling which could improve the accuracy of the training sample, so as to improve the classification accuracy of the topic classifier, meanwhile, performing evaluating the logistic regression model containing the optimal model parameters through the area AUC under the ROC curve to train the topic classifier, so as to perform classification to the text data, which could further improve the accuracy of topic classification.

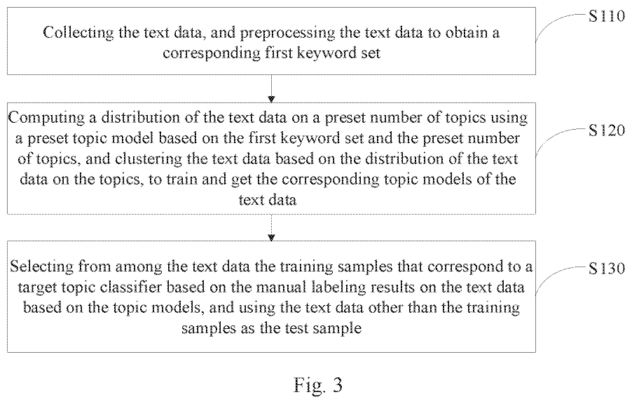

Based on the first embodiment illustrated in FIG. 2, referring to FIG. 3, FIG. 3 is a detailed flowchart illustrating obtaining a training sample and a test sample, wherein the training sample is obtained by manually labeling after a corresponding topic model having been trained based on text data of an embodiment according to the present disclosure, S100 includes:

S110, collecting the text data, and preprocessing the text data to obtain a corresponding first keyword set;

In the embodiment, the text data can be obtained from all major social networking platforms, such as Weibo, QQ Space, Zhihu, Baidu Tieba, etc., and can also be obtained from all major information resource databases, such as Tencent Video, CNKI, and EPaper, etc. In this embodiment, Weibo text is taken as an example, specifically, Weibo text data can be collected through Sina API (Application Programming Interface), and the text data includes main body and comment.

In the embodiment, the process of preprocessing the text data includes segmenting the text data, performing part-of-speech tagging, and then removing stop words in the text data after the segmentation based on a preset stop word list to obtain a second keyword set. Further, calculate the term frequency TF, the inverse document frequency IDF, and the term frequency-inverse document frequency TF-IDF value of each keyword in the second keyword set, and remove the keyword whose TF-IDF value is lower than the preset threshold of TF-IDF, to obtain the corresponding first keyword set.

S120, computing a distribution of the text data on a preset number of topics using a preset topic model based on the first keyword set and the preset number of topics, and clustering the text data based on the distribution of the text data on the topics, to train and get the corresponding topic models of the text data;

In the embodiment, the preset topic model is an LDA topic model, which is an unsupervised machine learning technology, configured to identify underlying topic information in large-scale document sets or corpuses, using probability distribution of underlying topics to represent each document in the document set, using probability distribution of lexical items to represent each underlying topic. Specifically, in the embodiment, when the terminal receives the input first keyword set and the set number of topics, the LDA topic model computes the distribution of the text data on a preset number of topics using a preset topic model based on the first keyword set and the preset number of topics. Further, clustering is performed based on the distribution of the text data on the topics, and the topic model corresponding to the text data is trained.

S130, selecting from among the text data the training samples that correspond to a target topic classifier based on the manual labeling results on the text data based on the topic models, and using the text data other than the training samples as the test sample.

In this embodiment, since the LDA model is a topic generation model, the type of the obtained topic cannot be controlled. Therefore, the obtained topic needs to be manually labeled to filter out the text data corresponding to the target topic as the training sample of the topic classifier, which facilitates to improve the classification accuracy of the topic classifier. In addition, text data other than the training sample is used as the test sample for evaluating the trained logistic regression model.

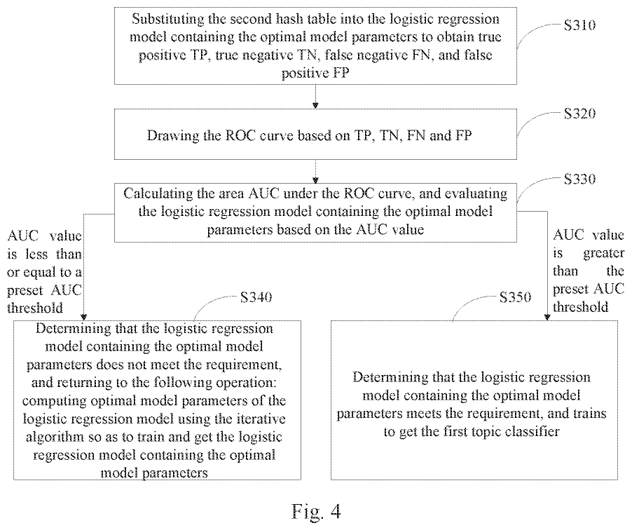

Based on the first embodiment illustrated in FIG. 2, referring to FIG. 4, FIG. 4 is a detailed flowchart illustrating drawing a ROC curve of receiver operating characteristic based on the features of the test sample and the logistic regression model containing the optimal model parameters, and evaluating the logistic regression model containing the optimal model parameters based on the area AUC under the ROC curve, to train and get a first topic classifier. S300 includes:

S310, substituting the second hash table into the logistic regression model containing the optimal model parameters to obtain true positive TP, true negative TN, false negative FN, and false positive FP;

S320, drawing the ROC curve based on TP, TN, FN and FP;

S330, calculating the area AUC under the ROC curve, and evaluating the logistic regression model containing the optimal model parameters based on the AUC value;

S340, when the AUC value is less than or equal to a preset AUC threshold, determining that the logistic regression model containing the optimal model parameters does not meet the requirement, and returning to the following operation: computing optimal model parameters of the logistic regression model using the iterative algorithm so as to train and get the logistic regression model containing the optimal model parameters;

S350, when the AUC value is greater than the preset AUC threshold, determining that the logistic regression model containing the optimal model parameters meets the requirement, and trains to get the first topic classifier.

In this embodiment, the second hash table is substituted into the logistic regression model containing the optimal model parameters to analyze the test sample, there exist the following four situations: if the text data belongs to a certain topic, meanwhile it is predicted to belong to the topic by the logistic regression model containing the optimal model parameters, then is true TP; if the text data does not belong to a certain topic meanwhile it is predicted not to belong to the topic, it is true negative TN; if the text data belongs to a certain topic but is predicted not to belong to the topic, it is false negative FN; if the text data does not belong to a certain topic but is predicted to belong to the topic, it is false positive FP.

Further, the ROC curve is drawn based on TP, TN, FN and FP Specifically, the ROC curve takes the false positive rate FPR as the abscissa and the true positive rate TPR as the ordinate. The specific calculation formula is as follows:

FPR=FP/(FP+TN),TPR=TP/(TP+FN).

Further, calculate the area AUC under the ROC curve, the calculation formula is as follows:

In this embodiment, the larger the AUC value, the better performance of the logistic regression model containing the optimal model parameters. When the calculated AUC value is less than or equal to the preset AUC threshold, it is determined that the logistic regression model with the optimal model parameters does not meet the requirement, and returns to the following operation: computing optimal model parameters of the logistic regression model using the iterative algorithm so as to train and get the logistic regression model containing the optimal model parameters. Until the AUC value is greater than the preset AUC threshold, it is determined that the logistic regression model containing the optimal model parameters meets the requirement, the first subject classifier is trained.

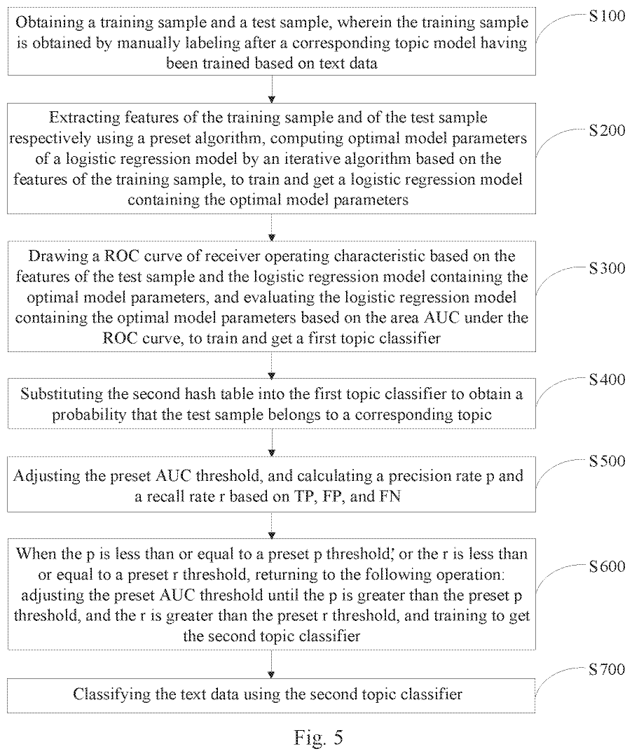

Based on the first embodiment illustrated in FIG. 2, referring to FIG. 5, FIG. 5 is a flowchart illustrating a second embodiment of the method for training a topic classifier according to the present disclosure. The method further includes:

S400, substituting the second hash table into the first topic classifier to obtain a probability that the test sample belongs to a corresponding topic;

S500, adjusting the preset AUC threshold, and calculating a precision rate p and a recall rate r based on TP, FP, and FN;

S600, when the p is less than or equal to a preset p threshold, or the r is less than or equal to a preset r threshold, returning to the following operation: adjusting the preset AUC threshold until the p is greater than the preset p threshold, and the r is greater than the preset r threshold, and training to get the second topic classifier;

S700, classifying the text data using the second topic classifier.

It should be noted that, with respect to the first embodiment shown in FIG. 2, the difference between the second embodiment shown in FIG. 4 is that, in actual use, due to excessive text data, the labor force for manual labeling sample is too large, may not be cover all possible text data, resulting in poor performance. In addition, when using the area AUC under the ROC curve to evaluate the logistic regression model containing the optimal model parameters, 0.5 is used as the preset AUC threshold by default, and if it is greater than 0.5, the predicted result of the logistic regression model is 1, indicating that it belongs to the topic; if less than or equal to 0.5, the prediction result of the logistic regression model is 0, which means that it does not belong to the topic. Therefore, in the second embodiment, by adjusting the preset AUC threshold, the classification accuracy of the second topic classifier is further improved while ensuring the precision rate p and the recall rate r.

In this embodiment, the second hash table is substituted into the first topic classifier to obtain the probability of the test sample belonging to the corresponding topic. Further, the preset AUC threshold is adjusted, and the precision rate p and the recall rate r are calculated based on TP, FP, and FN, the calculation formula is as follows:

When p is less than or equal to a preset threshold of the precision rate, or r is less than or equal to a preset threshold of the recall rate, returning to the following operation: adjusting the preset AUC threshold until p is greater than the preset threshold of the precision rate, and r is greater than the preset threshold of the recall rate, the second subject classifier is trained, classifying the text data using the second topic classifier.

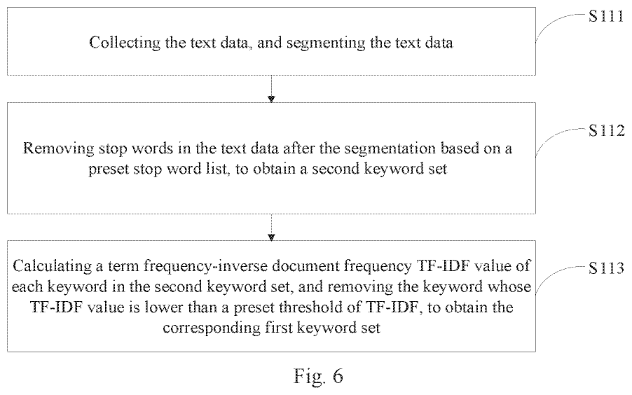

Based on the first embodiment illustrated in FIG. 3, referring to FIG. 6, FIG. 6 is a detailed flowchart illustrating collecting the text data, and preprocessing the text data to obtain a corresponding first keyword set of an embodiment according to the present disclosure. S110 includes:

S111, collecting the text data, and segmenting the text data;

S112, removing stop words in the text data after the segmentation based on a preset stop word list, to obtain a second keyword set;

S113, calculating a term frequency-inverse document frequency TF-IDF value of each keyword in the second keyword set, and removing the keyword whose TF-IDF value is lower than a preset threshold of TF-IDF, to obtain the corresponding first keyword set.

In the embodiment, the text data can be obtained from all major social networking platforms, such as Weibo, QQ Space, Zhihu, Baidu Tieba, etc., and can also be obtained from all major information resource databases, such as Tencent Video, CNKI, and EPaper, etc. In this embodiment, Weibo text is taken as an example, specifically, Weibo text data can be collected through Sina API (Application Programming Interface), and the text data includes main body and comment.

Further, perform preprocessing to the text data which includes segmenting the text data and performing part-of-speech tagging. It should be noted that the word segmentation process can be carried out through a word segmentation tool, such as Chinese Lexical Analysis System ICTCLAS, Tsinghua University Lexical Analyzer for Chinese THULAC, Language Technology Platform LTP and the like. The word segmentation mainly divides each Chinese text in the sample data into one by one word based on the characteristics of the Chinese language, and performs part-of-speech tagging.

Further, the pre-processing process further includes removing stop words in the text data after the segmentation based on the preset stop word list to obtain the second keyword set. The removal of the stop words is beneficial to increase the density of the keywords, thereby facilitating the determination of the topic to which the text data belongs. It should be noted that the stop words mainly include two categories: the first category is some words which are used too frequently, such as “I”, “just”, etc., such words appear in almost every document; the second category is some words which appear frequently in the text but have no real meaning, such words only have a certain meaning when they are put into a complete sentence, including modal auxiliary words, adverbs, prepositions, conjunctions, etc., such as “of”, “in”, “then” and so on.

Further, the preprocessing process includes calculating the term frequency-inverse document frequency TF-IDF value of each keyword in the second keyword set, and removing the keyword whose TF-IDF value is lower than a preset threshold of TF-IDF, to obtain the corresponding first keyword set. Specifically, first the term frequency TF and the inverse document frequency IDF are calculated, wherein TF represents the frequency of a certain keyword appearing in the current document, and IDF represents the distribution of the keyword in all of the documents of the text data, which is a measure of general importance of a word. The formula for calculating TF and IDF is as follows:

Wherein, n, represents the number of times the keyword appears in the current document, n represents the total number of keywords in the current document, N represents the total number of documents in the data set, and N, represents the number of documents in which the keyword appears in the text data set.

Further, calculate the TF-IDF value based on the formula TF-IDF=TF×IDF, remove the keyword whose TF-IDF value is lower than the preset threshold of TF-IDF, to obtain the corresponding first keyword set.

In addition, the present disclosure further provides a computer-readable storage medium, a topic classifier training program is stored on the computer-readable storage medium, the above operations of the method of training a topic classifier are performed when the topic classifier training program is executed by the processor.

The operations performed when the topic classifier training program is executed by the processor refer to various embodiments of the method of training the topic classifier of the present disclosure, details are not described herein.

In addition, the present disclosure further provides a device for training a topic classifier, which includes:

a first obtaining module, configured for obtaining a training sample and a test sample, wherein the training sample is obtained by manually labeling after a corresponding topic model having been trained based on text data;

a first training module, configured for extracting features of the training sample and of the test sample respectively using a preset algorithm, computing optimal model parameters of a logistic regression model by an iterative algorithm based on the features of the training sample, to train and get a logistic regression model containing the optimal model parameters; and

a second training module, configured for drawing a ROC curve of receiver operating characteristic based on the features of the test sample and the logistic regression model containing the optimal model parameters, and evaluating the logistic regression model containing the optimal model parameters based on the area AUC under the ROC curve, to train and get a first topic classifier.

Further, the first obtaining module includes:

a collecting unit, configured for collecting the text data, and preprocessing the text data to obtain a corresponding first keyword set;

a first training unit, configured for computing a distribution of the text data on a preset number of topics using a preset topic model based on the first keyword set and the preset number of topics, and clustering the text data based on the distribution of the text data on the topics, to train and get the corresponding topic models of the text data; and

a classifying unit, configured for selecting from among the text data the training samples that correspond to a target topic classifier based on the manual labeling results on the text data based on the topic models, and using the text data other than the training samples as the test sample.

Further, the first training unit includes:

an establishing unit, configured for extracting the features of the training sample and of the test sample respectively using a preset algorithm, and correspondingly establishing a first hash table and a second hash table;

a second training unit, configured for substituting the first hash table into the logistic regression model, and calculating the optimal model parameters of the logistic regression model using the iterative algorithm, to train and get the logistic regression model containing the optimal model parameters.

Further, the second training module includes:

an obtaining unit, configured for substituting the second hash table into the logistic regression model containing the optimal model parameters to obtain true positive TP, true negative TN, false negative FN, and false positive FP;

a drawing unit, configured for drawing the ROC curve based on TP, TN, FN and FP;

an evaluating unit, configured for calculating the area AUC under the ROC curve, and evaluating the logistic regression model containing the optimal model parameters based on the AUC value;

a determining unit, configured for when the AUC value is less than or equal to a preset AUC threshold, determining that the logistic regression model containing the optimal model parameters does not meet the requirement, and returning to the following operation: computing optimal model parameters of the logistic regression model using the iterative algorithm so as to train and get the logistic regression model containing the optimal model parameters;

a third training unit, configured for when the AUC value is greater than the preset AUC threshold, determining that the logistic regression model containing the optimal model parameters meets the requirement, and trains to get the first topic classifier.

Further, the drawing unit includes:

a calculating sub-unit, configured for calculating a false positive rate FPR and a true positive rate TPR based on TP, TN, FN, and FP, wherein their respective calculation formulas are FPR=FP/(FP+TN), TPR=TP/(TP+FN); and

a drawing sub-unit, configured for drawing the ROC curve taking the FPR as the abscissa and the TPR as the ordinate.

Further, the method for training a topic classifier further includes:

a second obtaining module, configured for substituting the second hash table into the first topic classifier to obtain a probability that the test sample belongs to a corresponding topic;

a first adjusting module, configured for adjusting the preset AUC threshold, and calculating a precision rate p and a recall rate r based on TP, FP, and FN;

a second adjusting module, configured for when the p is less than or equal to a preset p threshold, or the r is less than or equal to a preset r threshold, returning to the following operation: adjusting the preset AUC threshold until the p is greater than the preset p threshold, and the r is greater than the preset r threshold, and training to get the second topic classifier;

a classifying module, configured for classifying the text data using the second topic classifier.

Further, the collecting unit includes:

a collecting sub-unit, configured for collecting the text data, and segmenting the text data;

a removing sub-unit, configured for removing stop words in the text data after the segmentation based on a preset stop word list, to obtain a second keyword set;

a calculating sub-unit, configured for calculating a term frequency-inverse document frequency TF-IDF value of each keyword in the second keyword set, and removing the keyword whose TF-IDF value is lower than a preset threshold of TF-IDF, to obtain the corresponding first keyword set.

Further, the calculating sub-unit includes:

a first calculating sub-unit, configured for calculating the term frequency TF and the inverse document frequency IDF of each keyword in the second keyword set;

a second calculating sub-unit, configured for calculating the term frequency-inverse document frequency TF-IDF value of each keyword in the second keyword set, and removing the keyword whose TF-IDF value is lower than the preset threshold of TF-IDF, to obtain the corresponding first keyword set.

The operations performed when executing each module refer to various embodiments of the method of training the topic classifier of the present disclosure, details are not described herein.

It should be noted that, throughout this disclosure, the terms “include”, “comprise” or any other variations thereof are intended to encompass non-exclusive inclusions, so that a process, method, article, or system that includes a series of elements would include not only those elements, but it may further include other elements that are not explicitly listed or elements that are inherent to such processes, methods, articles, or systems. In the absence of extra limitations, an element defined by the phrase “includes a . . . ” does not exclude the presence of additional identical elements in this process, method, article, or system that includes the element.

Sequence numbers of the embodiments disclosed herein are meant for the sole purpose of illustrative and do not represent the advantages and disadvantages of these embodiments.

Through the above description of the foregoing embodiments, those skilled in the art can clearly understand that the above methods of the embodiments can be implemented by means of software plus a necessary general hardware platform; they certainly can also be implemented by means of hardware, but in many cases, the former is a better implementation. Based on this understanding, the essential part of the technical solution according to the present disclosure or the part that contributes to the prior art can be embodied in the form of a software product. Computer software products can be stored in a storage medium as described above (e.g., ROM/RAM, a magnetic disk, an optical disc) which includes instructions to cause a terminal device (e.g., a mobile phone, a computer, a server, an air conditioner, or a network device, etc.) to perform the methods described in the various embodiments of the present disclosure.

The foregoing description portrays merely some illustrative embodiments of the present disclosure, and is not intended to limit the patentable scope of the present disclosure. Any equivalent structural or flow transformations based on the specification and the drawing of the present disclosure, or any direct or indirect applications of the present disclosure in other related technical fields, shall all fall within the protection scope of the present disclosure.

1. A method for training a topic classifier, comprising:
obtaining a training sample and a test sample, wherein the training sample is obtained by manually labeling after a corresponding topic model having been trained based on text data;
extracting features of the training sample and of the test sample respectively using a preset algorithm, computing optimal model parameters of a logistic regression model by an iterative algorithm based on the features of the training sample, to train and get a logistic regression model containing the optimal model parameters; and
drawing a ROC curve of receiver operating characteristic based on the features of the test sample and the logistic regression model containing the optimal model parameters, and evaluating the logistic regression model containing the optimal model parameters based on the area AUC under the ROC curve, to train and get a first topic classifier.

2. The method of claim 1, wherein the step of obtaining a training sample and a test sample, wherein the training sample is obtained by manually labeling after a corresponding topic model having been trained based on text data comprises:
collecting the text data, and preprocessing the text data to obtain a corresponding first keyword set;
computing a distribution of the text data on a preset number of topics using a preset topic model based on the first keyword set and the preset number of topics, and clustering the text data based on the distribution of the text data on the topics, to train and get the corresponding topic models of the text data; and
selecting from among the text data the training samples that correspond to a target topic classifier based on the manual labeling results on the text data based on the topic models, and using the text data other than the training samples as the test sample.

3. The method of claim 2, wherein the step of extracting features of the training sample and of the test sample respectively using a preset algorithm, computing optimal model parameters of a logistic regression model by an iterative algorithm based on the features of the training sample, to train and get a logistic regression model containing the optimal model parameters comprises:
extracting the features of the training sample and of the test sample respectively using a preset algorithm, and correspondingly establishing a first hash table and a second hash table;
substituting the first hash table into the logistic regression model, and calculating the optimal model parameters of the logistic regression model using the iterative algorithm, to train and get the logistic regression model containing the optimal model parameters.

4. The method of claim 3, wherein the step of drawing a ROC curve of receiver operating characteristic based on the features of the test sample and the logistic regression model containing the optimal model parameters, and evaluating the logistic regression model containing the optimal model parameters based on the area AUC under the ROC curve, to train and get a first topic classifier comprises:
substituting the second hash table into the logistic regression model containing the optimal model parameters to obtain true positive TP, true negative TN, false negative FN, and false positive FP;
drawing the ROC curve based on TP, TN, FN and FP;
calculating the area AUC under the ROC curve, and evaluating the logistic regression model containing the optimal model parameters based on the AUC value;
when the AUC value is less than or equal to a preset AUC threshold, determining that the logistic regression model containing the optimal model parameters does not meet the requirement, and returning to the following operation: computing optimal model parameters of the logistic regression model using the iterative algorithm so as to train and get the logistic regression model containing the optimal model parameters;
otherwise when the AUC value is greater than the preset AUC threshold, determining that the logistic regression model containing the optimal model parameters meets the requirement, and trains to get the first topic classifier.

5. (canceled)

6. The method of claim 4, further comprising:
substituting the second hash table into the first topic classifier to obtain a probability that the test sample belongs to a corresponding topic;
adjusting the preset AUC threshold, and calculating a precision rate p and a recall rate r based on TP, FP, and FN;
when the p is less than or equal to a preset p threshold, or the r is less than or equal to a preset r threshold, returning to the following operation: adjusting the preset AUC threshold until the p is greater than the preset p threshold, and the r is greater than the preset r threshold, and training to get the second topic classifier;
classifying the text data using the second topic classifier.

7. The method of claim 2, wherein the step of collecting the text data, and preprocessing the text data to obtain a corresponding first keyword set comprises:
collecting the text data, and segmenting the text data;
removing stop words in the text data after the segmentation based on a preset stop word list, to obtain a second keyword set;
calculating a term frequency-inverse document frequency TF-IDF value of each keyword in the second keyword set, and removing the keyword whose TF-IDF value is lower than a preset threshold of TF-IDF, to obtain the corresponding first keyword set.

8. (canceled)

9. A device for training a topic classifier, comprising:
a memory,
a processor, and
a topic classifier training program stored in the memory and executable on the processor, the topic classifier training program when executed by the processor performing the following operations:
obtaining a training sample and a test sample, wherein the training sample is obtained by manually labeling after a corresponding topic model having been trained based on text data;
extracting features of the training sample and of the test sample respectively using a preset algorithm, computing optimal model parameters of a logistic regression model by an iterative algorithm based on the features of the training sample, to train and get a logistic regression model containing the optimal model parameters; and
drawing a ROC curve of receiver operating characteristic based on the features of the test sample and the logistic regression model containing the optimal model parameters, and evaluating the logistic regression model containing the optimal model parameters based on the area AUC under the ROC curve, to train and get a first topic classifier.

10. The device of claim 9, wherein following operations are further performed when the topic classifier training program executed by the processor:
collecting the text data, and preprocessing the text data to obtain a corresponding first keyword set;
computing a distribution of the text data on a preset number of topics using a preset topic model based on the first keyword set and the preset number of topics, and clustering the text data based on the distribution of the text data on the topics, to train and get the corresponding topic models of the text data; and
selecting from among the text data the training samples that correspond to a target topic classifier based on the manual labeling results on the text data based on the topic models, and using the text data other than the training samples as the test sample.

11. The device of claim 10, wherein following operations are further performed when the topic classifier training program executed by the processor:
extracting the features of the training sample and of the test sample respectively using a preset algorithm, and correspondingly establishing a first hash table and a second hash table;
substituting the first hash table into the logistic regression model, and calculating the optimal model parameters of the logistic regression model using the iterative algorithm, to train and get the logistic regression model containing the optimal model parameters.

12. The device of claim 11, wherein following operations are further performed when the topic classifier training program executed by the processor:
substituting the second hash table into the logistic regression model containing the optimal model parameters to obtain true positive TP, true negative TN, false negative FN, and false positive FP;
drawing the ROC curve based on TP, TN, FN and FP;
calculating the area AUC under the ROC curve, and evaluating the logistic regression model containing the optimal model parameters based on the AUC value;
when the AUC value is less than or equal to a preset AUC threshold, determining that the logistic regression model containing the optimal model parameters does not meet the requirement, and returning to the following operation: computing optimal model parameters of the logistic regression model using the iterative algorithm so as to train and get the logistic regression model containing the optimal model parameters;
otherwise when the AUC value is greater than the preset AUC threshold, determining that the logistic regression model containing the optimal model parameters meets the requirement, and trains to get the first topic classifier.

13. (canceled)

14. The device of claim 12, wherein following operations are further performed when the topic classifier training program executed by the processor:
substituting the second hash table into the first topic classifier to obtain a probability that the test sample belongs to a corresponding topic;
adjusting the preset AUC threshold, and calculating a precision rate p and a recall rate r based on TP, FP, and FN;
when the p is less than or equal to a preset p threshold, or the r is less than or equal to a preset r threshold, returning to the following operation: adjusting the preset AUC threshold until the p is greater than the preset p threshold, and the r is greater than the preset r threshold, and training to get the second topic classifier;
classifying the text data using the second topic classifier.

15. The device of claim 10, wherein following operations are further performed when the topic classifier training program executed by the processor:
collecting the text data, and segmenting the text data;
removing stop words in the text data after the segmentation based on a preset stop word list, to obtain a second keyword set;
calculating a term frequency-inverse document frequency TF-IDF value of each keyword in the second keyword set, and removing the keyword whose TF-IDF value is lower than a preset threshold of TF-IDF, to obtain the corresponding first keyword set.

16. The device of claim 15, wherein following operations are further performed when the topic classifier training program executed by the processor:
calculating the term frequency TF and the inverse document frequency IDF of each keyword in the second keyword set;
calculating the term frequency-inverse document frequency TF-IDF value of each keyword in the second keyword set, and removing the keyword whose TF-IDF value is lower than the preset threshold of TF-IDF, to obtain the corresponding first keyword set.

17. A computer-readable storage medium, wherein a topic classifier training program is stored in the computer-readable storage medium, the topic classifier training program when executed by the processor performing the following operations:
obtaining a training sample and a test sample, wherein the training sample is obtained by manually labeling after a corresponding topic model having been trained based on text data;
extracting features of the training sample and of the test sample respectively using a preset algorithm, computing optimal model parameters of a logistic regression model by an iterative algorithm based on the features of the training sample, to train and get a logistic regression model containing the optimal model parameters; and
drawing a ROC curve of receiver operating characteristic based on the features of the test sample and the logistic regression model containing the optimal model parameters, and evaluating the logistic regression model containing the optimal model parameters based on the area AUC under the ROC curve, to train and get a first topic classifier.

18. The computer-readable storage medium of claim 17, wherein following operations are further performed when the topic classifier training program executed by the processor:
collecting the text data, and preprocessing the text data to obtain a corresponding first keyword set;
computing a distribution of the text data on a preset number of topics using a preset topic model based on the first keyword set and the preset number of topics, and clustering the text data based on the distribution of the text data on the topics, to train and get the corresponding topic models of the text data; and
selecting from among the text data the training samples that correspond to a target topic classifier based on the manual labeling results on the text data based on the topic models, and using the text data other than the training samples as the test sample.

19. The computer-readable storage medium of claim 18, wherein following operations are further performed when the topic classifier training program executed by the processor:
extracting the features of the training sample and of the test sample respectively using a preset algorithm, and correspondingly establishing a first hash table and a second hash table;
substituting the first hash table into the logistic regression model, and calculating the optimal model parameters of the logistic regression model using the iterative algorithm, to train and get the logistic regression model containing the optimal model parameters.

20. The computer-readable storage medium of claim 19, wherein following operations are further performed when the topic classifier training program executed by the processor:
substituting the second hash table into the logistic regression model containing the optimal model parameters to obtain true positive TP, true negative TN, false negative FN, and false positive FP;
drawing the ROC curve based on TP, TN, FN and FP;
calculating the area AUC under the ROC curve, and evaluating the logistic regression model containing the optimal model parameters based on the AUC value;
when the AUC value is less than or equal to a preset AUC threshold, determining that the logistic regression model containing the optimal model parameters does not meet the requirement, and returning to the following operation: computing optimal model parameters of the logistic regression model using the iterative algorithm so as to train and get the logistic regression model containing the optimal model parameters;
otherwise when the AUC value is greater than the preset AUC threshold, determining that the logistic regression model containing the optimal model parameters meets the requirement, and trains to get the first topic classifier.

21. (canceled)

22. The computer-readable storage medium of claim 20, wherein following operations are further performed when the topic classifier training program executed by the processor:
substituting the second hash table into the first topic classifier to obtain a probability that the test sample belongs to a corresponding topic;
adjusting the preset AUC threshold, and calculating a precision rate p and a recall rate r based on TP, FP, and FN;
when the p is less than or equal to a preset p threshold, or the r is less than or equal to a preset r threshold, returning to the following operation: adjusting the preset AUC threshold until the p is greater than the preset p threshold, and the r is greater than the preset r threshold, and training to get the second topic classifier;
classifying the text data using the second topic classifier.

23. The computer-readable storage medium of claim 18, wherein following operations are further performed when the topic classifier training program executed by the processor:
collecting the text data, and segmenting the text data;
removing stop words in the text data after the segmentation based on a preset stop word list, to obtain a second keyword set;
calculating a term frequency-inverse document frequency TF-IDF value of each keyword in the second keyword set, and removing the keyword whose TF-IDF value is lower than a preset threshold of TF-IDF, to obtain the corresponding first keyword set.

24. The computer-readable storage medium of claim 23, wherein following operations are further performed when the topic classifier training program executed by the processor:
calculating the term frequency TF and the inverse document frequency IDF of each keyword in the second keyword set;
calculating the term frequency-inverse document frequency TF-IDF value of each keyword in the second keyword set, and removing the keyword whose TF-IDF value is lower than the preset threshold of TF-IDF, to obtain the corresponding first keyword set.

25-32. (canceled)
